(19) United States
(12) Patent Application Publication
(10) Pub. No.: US 2025/0093657 A1
(43) Pub. Date: Mar. 20, 2025

(54) Diffractive Waveguide Combiners with Compensated-Wrap for Rainbow Mitigation

(71) Applicant: Applied Materials, Inc., Santa Clara, CA (US)

(72) Inventors: Simon LORENZO, Santa Clara, CA (US); Evan WANG, Palo Alto, CA (US); Kevin MESSER, Mountain View, CA (US); Samarth BHARGAVA, Saratoga, CA (US)

(21) Appl. No.: 18/883,836

(22) Filed: Sep. 12, 2024

Related U.S. Application Data
(60) Provisional application No. 63/583,148, filed on Sep. 15, 2023.

(51) Int. Cl. G02B 27/01

(52) U.S. Cl. CPC G02B 27/0172; G02B 2027/012

(57) ABSTRACT

Embodiments herein are generally directed to a waveguide display assembly and a near-eye display system incorporating the waveguide display assembly. In an embodiment, the waveguide display includes a light engine, a waveguide combiner, an input coupling grating, and one or more coupling gratings exposed to an ambient environment of the waveguide display assembly. The waveguide combiner extends across a user's eye at a wrap angle θ_{wrap(xy)} relative to a waveguide plane, and the light engine is configured to project light toward the input coupling grating at a compensation angle θ_{Cl} so as to increase the grating vector of the exposed gratings and reduce the angles and wavelengths at which light can be diffracted and coupled by the exposed grating into the waveguide combiner to the user's eye.

### RELATED APPLICATIONS

This application claims benefit of and priority to U.S. Provisional Application No. 63/583,148 filed Sep. 15, 2023 which is herein incorporated in its entirety by reference for all purposes.

### BACKGROUND

### Field

Embodiments described herein generally relate to near-eye display systems, and more specifically to near-eye display systems with reduced rainbow artifacts and methods of forming the same.

### Description of the Related Art

Virtual reality (VR) is generally considered to be a computer generated simulated environment in which a user has an apparent physical presence. A virtual reality experience can be generated in 3D and viewed with a head-mounted display (HMD), such as glasses or other wearable display devices that have near-eye display panels as lenses to display a virtual reality environment that replaces an actual environment.

Augmented reality (AR), however, enables an experience in which a user can still see through the display lenses of the glasses or other HMD device to view the surrounding environment, yet also see images of virtual objects that are generated for display and appear as part of the environment. AR can include any type of input, such as audio and haptic inputs, as well as virtual images, graphics, and video that enhance or augment the environment that the user experiences. As an emerging technology, there are many challenges and design constraints with augmented reality.

Typical diffractive near-eye display systems suffer from external light source diffraction, for example, a rainbow artifact, which results in the appearance of a single or multi-color streak of light in the user's field of view (FOV). This rainbow artifact is an unwanted diffraction to the user experience in an AR display system.

Accordingly, what is needed in the art are near-eye display systems with reduced rainbow artifacts.

### SUMMARY

Embodiments described herein generally relate to near-eye display systems, and more specifically to near-eye display systems with reduced rainbow artifacts.

In an embodiment, a waveguide display is provided. The waveguide display includes a light engine and a waveguide combiner configured to extend across a user's eye at a wrap angle θ_{wrap(xy)} relative to a waveguide plane. The light engine is configured to project light, and the waveguide display includes an input coupling grating for coupling light from the light engine into the waveguide combiner. The waveguide display also includes one or more coupling gratings exposed to an ambient environment of the waveguide display assembly. The waveguide plane is substantially parallel with an eyebox plane in front of the user's eye, and the light engine is configured to project light toward the input coupling grating at a compensation angle θ_{Cl} determined using the wrap angle θ_{wrap(xy)} and following equation: θ_{Cl}=90°−(2×θ_{wrap(xy)}).

In another embodiment, a near-eye display system is provided. The system includes a frame, a light engine to project light, and a waveguide display. The waveguide display includes a waveguide combiner, an input coupling grating, and one or more coupling gratings formed on or in a surface of the waveguide combiner. The waveguide combiner is configured to extend across a user's eye at a wrap angle θ_{wrap(xy)} relative to a waveguide plane. The input coupling grating couples from the light engine into the waveguide combiner. The one or more coupling gratings are exposed to an ambient environment of the waveguide display assembly. The waveguide plane is substantially parallel with an eyebox plane in front of the user's eye, and the light engine is configured to project light toward the input coupling grating at a compensation angle θ_{Cl} determined using the wrap angle θ_{wrap(xy)} and following equation: θ_{Cl}=90°−(2×θ_{wrap(xy)}).

In another embodiment, a near-eye display system is provided. The system includes a frame and a waveguide display assembly. The waveguide display assembly includes a waveguide combiner extending at a wrap angle θ_{wrap(xy)} relative to a waveguide plane, wherein the waveguide plane is substantially parallel with an eyebox plane in front of a user's eye. The waveguide display assembly also includes an out-coupler grating having a pitch (Δₓ, Δ_{y}). The wrap angle θ_{wrap(xy)} of the waveguide combiner increases a grating vector k_{grating} of the out-coupler grating such that all angles of incidence θᵢₙ of light from an external light source results in a diffracted angle θₒᵤₜ, that produces no visible rainbow artifacts within a 30 degrees field of view (FOV) cone of a user by satisfying the following equation:

$${θ}_{out} = {sin}^{- 1} ( \frac{{n}_{i n} sin ( {θ}_{i n} ) - m \times {k}_{grating , norm} \times sin ( {ϕ}_{grating} )}{{n}_{out}} )$$

wherein nₒᵤₜ is the refractive index of the “out” medium external to the out-coupler grating, nᵢₙ is the refractive index of the “in” medium of the out-coupler grating, m is the grating diffraction order, and k_{grating, norm} is the normalized grating vector of the out-coupler grating.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, and may admit to other equally effective embodiments.

FIG. 1 illustrates a perspective view of a near-eye display system, according to certain embodiments of the present disclosure,

FIG. 2 illustrates a cross-sectional view of the near-eye display system of FIG. 1, according to certain embodiments of the present disclosure;

FIG. 3 a cross-sectional view of an exemplary waveguide display that may be implemented in the near-eye display system of FIG. 1, according to certain embodiments of the present disclosure;

FIG. 4 illustrates a cross-sectional view of propagations of incident and external light beams in an exemplary waveguide display that may be implemented in the near-eye display system of FIG. 1, according to certain embodiments of the present disclosure;

FIGS. 5A-5C illustrate a perspective, cross-sectional, and corresponding K-Space diagram of a grating architecture, according to certain embodiments of the present disclosure;

FIGS. 6A and 6B illustrate a plan view and a side view of the near-eye display system of FIG. 1, according to certain embodiments of the present disclosure;

FIG. 7A illustrates a K-Space diagram of a grating vector architecture;

FIG. 7B illustrates a K-Space diagram of the grating vector architecture of FIG. 7B with compensated wrap applied, according to certain embodiments of the present disclosure;

FIG. 8 illustrates a K-Space diagram of the grating vector architecture of grating vectors that support and don't support rainbow artifacts, according to certain embodiments of the present disclosure; and

FIGS. 9A-9H illustrate exemplary grating architectures that may be implemented in the near-eye display system of FIG. 1, according to certain embodiments of the present disclosure.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

The following disclosure generally describes display systems for virtual reality and augmented reality. Certain details are set forth in the following description and in the figures to provide a thorough understanding of various implementations of the disclosure. Other details describing well-known structures and systems often associated with display systems for virtual reality and augmented reality are not set forth in the following disclosure to avoid unnecessarily obscuring the description of the various implementations.

Many of the details, dimensions, angles and other features shown in the Figures are merely illustrative of particular implementations. Accordingly, other implementations can have other details, components, dimensions, angles and features without departing from the spirit or scope of the present disclosure. In addition, further implementations of the disclosure can be practiced without several of the details described below.

Typical diffractive near-eye displays suffer from external light source diffraction (rainbow artifact), which results in the appearance of a single or multi-colored streak of light in the user's field-of-view. Such external sources include room lights and the sun. This rainbow artifact is an unwanted distraction to the user experience in an augmented reality display system. Embodiments described herein generally relate to near-eye display systems, and more specifically to near-eye display systems with reduced rainbow artifacts and methods of forming the same. The near-eye-display system utilizes a diffractive waveguide combiner having an increased grating vector that decreases the range of angles and wavelengths of external light beams from the ambient environment diffracting into the user's eye thereby producing rainbow artifacts. The increased grating vector therefore reduces the range of possible solid angles at which rainbow artifacts can occur and the centrality of such rainbow artifacts in the user's field of view. A set of relationships and constraints on the waveguide combiner and optical system design are provided to prevent rainbow artifacts from reaching the user's eye in normal operation.

Current near-eye display designs either live with the issue, mitigate the issue with complex grating structures, use external films to mitigate the issue, or use visor-like mechanical features to block the undesirable light paths. In contrast, in some embodiments of the present disclosure, rainbow artifacts are eliminated and/or minimized by utilizing a combination of the waveguide display assemblies of the near-eye display system oriented at a wrap angle relative to the eye of the user (referred to herein as adding a “wrap” or “wrapping” the waveguide display assemblies) and configuring the grating architecture of the same with shorter grating periods to generally increase the grating vector of exposed gratings and reduce the angles and wavelengths at which external light can be diffracted by the exposed grating architecture of the near-eye display system and coupled into the waveguide to reach the user's eye.

By utilizing the design relationships and constraints outlined in the present disclosure, the display system described herein minimizes the presence of rainbow artifacts in the user's field-of-view. In some embodiments, the display system described herein may eliminate rainbow artifacts from the user's field-of-view, partially eliminate rainbow artifacts from a portion of the user's field-of-view, or limiting the rainbow artifacts in the user's field-of-view to certain wavelengths or colors of the light. In some embodiments, the display system described herein may eliminate rainbow artifacts in a 30 degrees FOV cone. In some embodiments, the display system described herein may limit rainbow artifacts outside a 30 degrees FOV cone to only blue rainbow artifacts. Unlike other approaches to mitigating this artifact, some embodiments described herein do not use any external device or layers to filter the light from sources in the world which is incident on the waveguide-combiner. Additionally, some embodiments described herein do not use any visor-like mechanical blockages that extend beyond the plane of the waveguide combiner to prevent light paths that generate “rainbow” artifacts from hitting the waveguide combiner.

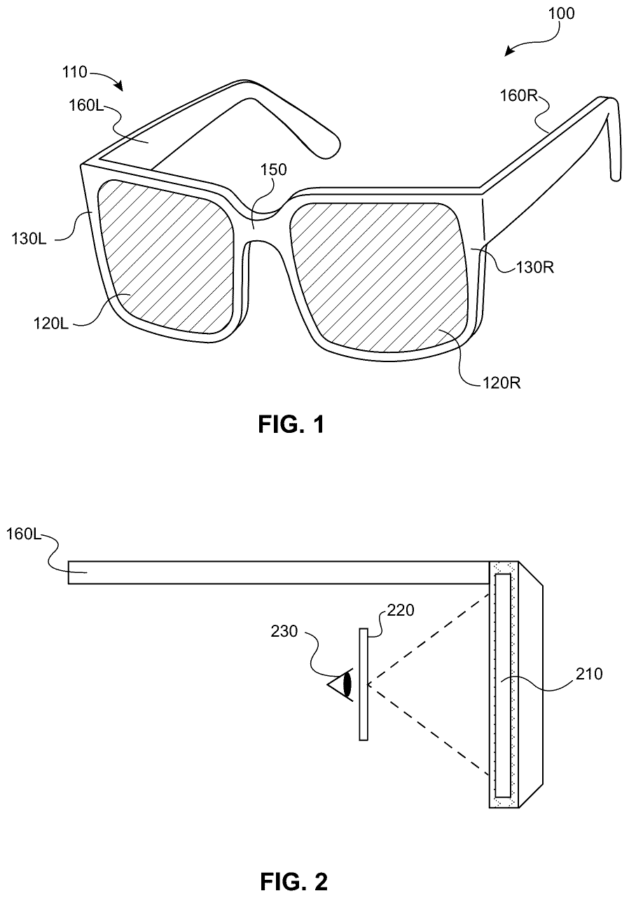

FIG. 1 illustrates a perspective view of a near-eye display system 100 according to certain embodiments of the present disclosure. The near-eye display system 100 can present media to a user. Examples of media presented by the near-eye display system 100 can include one or more images, video, and/or audio. In one embodiment, which can be combined with other embodiments, audio may be presented via an external device (e.g., speakers and/or headphones) that receives audio information from the near-eye display system 100, a console, or both, and presents audio data based on the audio information. The near-eye display system 100 is generally configured to operate as an artificial reality display. In one embodiment, which can be combined with other embodiments, the near-eye display system 100 can operate as an augmented reality (AR) display. The near-eye display system 100 includes optical components arranged to transport light of the desired media generated on the display to the user's eye to make the media visible to the user. The display of the near-eye display system 100 on which the image is generated can form part of a light engine, such that the image itself generates collimated lights beams which can be guided by the optical component to provide an image visible to the user.

In some embodiments, the optical components used to convey the image from the display to the user include optical waveguides and grating architectures. Such waveguide-based display systems typically transport light from a light engine to the eye via total internal reflection in a waveguide. Such systems can also incorporate diffraction gratings, which cause effective beam expansion so as to output expanded versions of the beams provided by the light engine. This causes the image to be visible to the user over a wider area when looking at the waveguide's output than when looking at the light engine directly. In such near-eye display systems, the area the eye of the user would need to be in to receive some light from substantially most or all of the expanded beams such that the whole image is visible to the user is referred to as the “eyebox.” The eyebox may be thought of as a volume in space positioned near the optical device. When the eye of the user (and more particularly, the pupil of the eye of the user) is positioned inside this volume and facing the device, the user is able to see all of the content/imagery provided by the device. When the eye of the user is positioned outside of this volume, the user is not able to see at least some of the content/imagery provided by the device.

The near-eye display system 100 can include a frame 110, a left display system 120L, and a right display system 120R. The left display system 120L may be supported in a left portion 130L of the frame 110. The right display system 120R may be supported in a right portion 130R of the frame 110. The frame 110 may include any suitable type of mounting structures to mount the right display system 120R and the left display system 120L adjacent a user's eyes. The right display system 120R and the left display system 120L may be configured to enable the user to view content presented by the near-eye display system 100. The left and right portions 130L, 130R of the frame 110 connect at a central portion 150. The central portion 150 of the frame 110 is intended to fit over the nose bridge of a user. The frame 110 also includes a left temporal extension 160L and a right temporal extension 160R configured to fit over the user's ears. The frame 110 can be coupled to one or more optical components. In some embodiments, the right display system 120R and the left display system 120L may include any suitable display assembly (not shown) configured to generate a virtual image or an image light of the virtual image and to direct the image light to an eye of the user.

FIG. 2 illustrates a cross-sectional view of the near-eye display system 100 of FIG. 1 according to certain embodiments of the present disclosure. FIG. 2 shows the cross-sectional portion of the near-eye display system 100 associated with the left display system 120L. In some embodiments, the left display system 120L may include a waveguide display assembly 210. The waveguide display assembly 210 is configured to direct image light, for example display light, to an eyebox plane 220 defining an eyebox and then to a user's eye 230. The waveguide display assembly 210 can include one or more materials with one or more refractive indices. In one embodiment, which can be combined with other embodiments, the near-eye display system 100 can include one or more optical elements between the waveguide display assembly 210 and the user's eye 230. The waveguide display assembly 210 may effectively minimize the weight and widen the field of view (“FOV”) of the near-eye display system 100. In one embodiment, which can be combined with other embodiments, the near-eye display system 100 can include one or more optical elements between the waveguide display assembly 210 and the user's eye 230. Examples of the one or more optical elements may include an aperture, a Fresnel lens, a convex lens, a concave lens, a filter, or any other suitable optical element that affects an image light. In some embodiments, the waveguide display assembly 210 may include a stack of waveguide displays.

FIG. 2 shows the left display system 120L associated with an eye 230 and a waveguide display assembly 210. As shown, the waveguide display assembly 210 may be for one eye 230 of the user. The waveguide display assembly 210 for one eye may be separated or partially separated from the waveguide display assembly 210 for the other eye. In certain embodiments, a single waveguide display assembly may be used for both eyes of the user. In some embodiments, another display assembly that is separate from the waveguide display assembly 210 shown in FIG. 2 may provide the image light to an eye-box for another eye of the user.

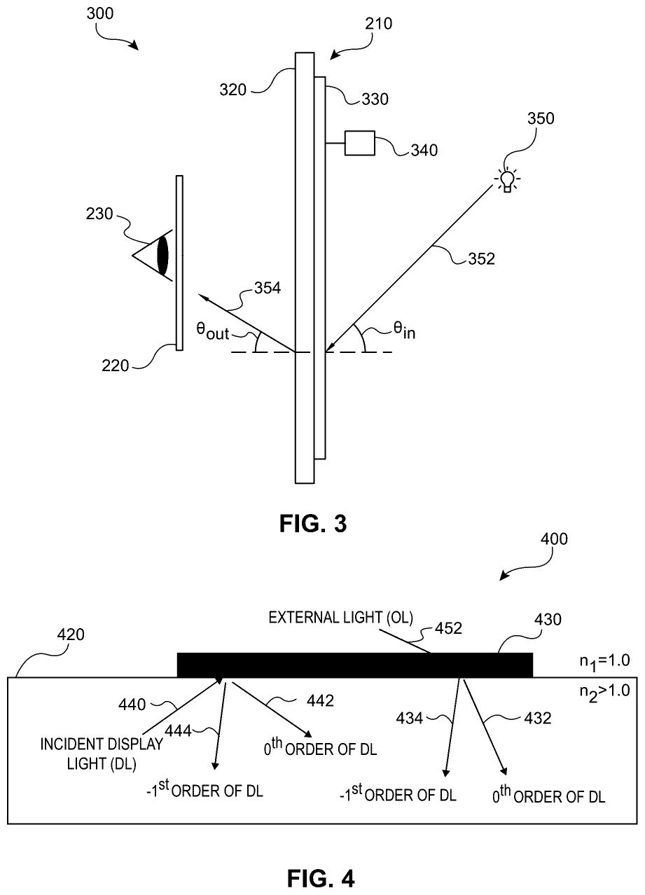

FIG. 3 illustrates a cross-sectional view of a waveguide display 300 according to one or more embodiments of the present disclosure. FIG. 3 illustrates rainbow artifacts in the waveguide display 300. The waveguide display 300 includes the waveguide display assembly 210 having a waveguide combiner 320 and an output coupling grating 330. The waveguide combiner 320 may be configured to propagate light within the waveguide by total internal reflection (TIR). The waveguide combiner 320 may each be planar or have another shape (e.g., curved). In some embodiments, the waveguide display 300 can further include a light engine, such as a projector 340. Display light from the projector 340 can be coupled into the waveguide combiner 320, for example, by an input coupling grating (not shown) and then subsequently partially coupled out of the waveguide combiner 320 at different locations by the output coupling grating 330 to reach the user's eye 230. External light beam 352 from an external light source 350, for example, the sun or a lamp, can also be diffracted by the output coupling grating 330 into the waveguide combiner 320 and then propagate through the waveguide combiner 320 to reach the user's eye 230. The diffraction of the external light beam 352 can be understood by looking at the following first order diffraction equation (I):

$$sin ( {θ}_{out} ) = sin ( {θ}_{in} ) + / - \frac{λ}{{Λ}_{OC}} \qquad ( I )$$

where θₒᵤₜ is the angle of light 354 diffracted by an exposed grating of the waveguide display 300, for example, the output coupling grating 330, θᵢₙ is the angle of external light beam 352 incident on the output coupling grating 330, λ is the wavelength of light 354, and Λ_{OC} is the period of the output coupling grating 330. The diffraction of external light beam 352 by the grating architecture of the waveguide display 300 exposed to the external and/or ambient environment can therefore lead to the presence of rainbow artifacts.

In some embodiments, the output coupling grating 330 may be configured to extract light out of a waveguide by redirecting the light, propagating within and out of the waveguide to output image information to the eye 230. Extracted light may also be referred to as out-coupled light and the output coupling grating 330 may also be referred to light extracting optical elements. An extracted beam of light may be output by the waveguide combiner 320 at locations at which the light propagating in the waveguide combiner 320 strikes a light extracting optical element of the output coupling grating 330. The output coupling grating 330 may be disposed at the left and/or right major surfaces (e.g., the output coupling grating 330 is disposed on the right major surface as shown in FIG. 3), and/or may be disposed directly in the volume of the waveguide combiner 320. In some embodiments, the output coupling grating 330 may be formed in a layer of material that is attached to a transparent substrate to form the waveguide combiner 320. In some other embodiments, the waveguide combiner 320 may be a monolithic piece of material and the output coupling grating 330 may be formed on a surface and/or in the interior of that piece of material.

In some embodiments, the waveguide display 300 can further include a projector 340 configured to generate an image light and guide the image light toward the waveguide combiner 320. The projector 340 may function as a source of light for the waveguide combiner 320 and may be utilized to inject image information into the waveguide combiner 320, which may be configured to distribute incoming light across the waveguide combiner 320, for output toward an eye 230. Display light from the projector 340 can be coupled into the waveguide combiner 320 by an incoupling optical element, such as an input coupling grating. Once coupled into the waveguide combiner 320, the display light can be partially coupled out of the waveguide combiner 320 at different locations by the output coupling grating 330 to reach the user's eye 230. However, as mentioned above, external light beam 352 from an external light source 350, for example, the sun or a lamp, can also be diffracted by the output coupling grating 330 into the waveguide combiner 320 and then propagate through the waveguide combiner 320 to reach the user's eye 230. This external light beam 352 can lead to the presence of rainbow artifacts in the user's field-of-view. In some embodiments, the projector 340, or one or more components thereof, may be attached to the frame 110. For example, the projector 340 may be part of the left and right temporal extensions 160L, 160R of the frame 110 or disposed at an edge of the waveguide display assemblies 210.

FIG. 4 illustrates propagations of incident display light 440 and external light 452 in an example waveguide display 400 including a waveguide combiner 420 and an output coupling grating 430. Waveguide combiner 420 may be a flat or curved transparent substrate with a refractive index n2 greater than the free space refractive index n1 (i.e., 1.0). Output coupling grating 430 may be, for example, a Bragg grating or a surface-relief grating.

As shown in FIG. 4, incident display light 440 from a light engine, such as the projector 340, may be coupled into the waveguide combiner 420 by, for example, an in-coupler diffraction grating. Incident display light 440 may propagate within waveguide combiner 420 through, for example, total internal reflection. When incident display light 440 reaches output coupling grating 430, incident display light 440 may be diffracted by output coupling grating 430 into, for example, a 0th order diffraction (i.e., reflection) light 442 and a −1st order diffraction light 444. The 0th order diffraction may propagate within waveguide combiner 420, and may be reflected by the bottom surface of waveguide combiner 420 towards output coupling grating 430 at a different location. The −1st order diffraction light 442 may be coupled out of waveguide combiner 420 towards the user's eye, because a total internal reflection condition may not be met at the bottom surface of waveguide combiner 420 due to the diffraction angle.

External light 452 may also be diffracted and coupled into waveguide combiner 420 by diffraction gratings disposed on or in a surface of the waveguide combiner 420 exposed to the ambient environment. Such diffraction gratings of the waveguide display assembly 210 may also be exposed to the ambient environment and therefore external light 452. For example, external light 452 can be diffracted by output coupling grating 430 (or any other grating exposed to the external environment) into, for example, a 0th order diffraction light 432 and a −1st order diffraction light 434.

Both the 0th order diffraction light 432 and the −1st order diffraction light 434 may be refracted out of waveguide combiner 420 towards the user's eye. Thus, output coupling grating 430 may act as an input coupler for coupling external light 452 into waveguide combiner 420, and may also act as an output coupler for coupling incident display light 440 out of waveguide combiner 420. As such, output coupling grating 430 may act as a combiner for combining external light 452 and incident display light 440. Due to the chromatic dispersion of the output coupling grating 430, lights of different colors may be diffracted at different angles for diffractions with a diffraction order greater or less than zero. As such, the −1st order diffractions of external light of different colors that reach the user's eye may appear as a rainbow artifact.

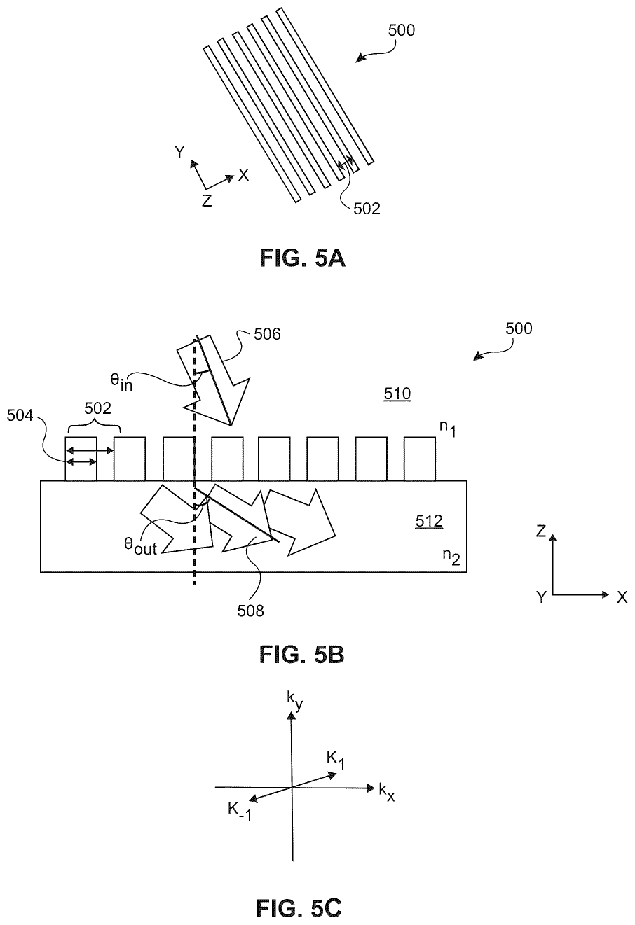

FIGS. 5A-5C illustrate an exemplary diffraction grating 500 and its associated K-Space diffraction grating vectors. FIG. 5A shows the diffraction grating 500 oriented in the x-y plane from the perspective of a light ray or beam which is incident upon the diffraction grating 500 from the z-direction. FIG. 5B shows an x-z cross-sectional view of the diffraction grating 500 having a grating periodicity corresponding to a pitch 502 (Λ_{X}) and a duty cycle 504. Generally, diffraction gratings are periodic optical structures that diffract an input light 506 from a medium 510 (e.g., air) having a lesser refractive index, n₁ into diffracted light 508 in a substrate medium 512 (e.g., waveguide combiner or waveguide body) with a higher refractive index, n₂, with the diffracted light 508 having wavelength-dependent direction. For example, when light composed of different wavelengths (e.g., white light) enters the grating, the light components are diffracted at angles that are determined by the respective wavelengths. The diffraction of input light 506 into the substrate medium 512 may be explained by the following standard grating equation (II):

$${n}_{out} sin ( {θ}_{out} ) = {n}_{in} sin ( {θ}_{in} ) + m \frac{{λ}_{o}}{Λ} sin ( {ϕ}_{grat} ) \qquad ( II )$$

where nₒᵤₜ is the refractive index of the “out” medium (e.g., n₂), θₒᵤₜ is the angle of light in that medium, nᵢₙ is the refractive index of the “in” medium (e.g., n₁), θᵢₙ is the angle of light incident from that medium, m (0, +−1, +−2, . . . ) is the grating diffraction order, λₒ is the wavelength of light in a vacuum, A is the grating pitch 502 of the diffraction grating 500, and ϕ_{grat} is the angle of the gratings of the diffraction grating 500.

As shown in FIG. 5C, the diffraction grating 500 has an associated set of K-Space diffraction grating vectors (e.g., K₋₁, K₁) oriented in the same plane as the diffraction grating 500. The K₁ and K₋₁ grating vectors correspond to the ±1 diffractive orders, respectively. The grating vectors for the ±1 diffractive orders point in opposite directions (along the axis of periodicity of the grating) and have equal magnitudes which are inversely proportional to the periodicity or pitch 502 of the diffraction grating 500. Generally, the grating vector k_{grating} of a diffraction grating is determined by the following grating vector equation (III):

$${k}_{grating} = 2 π * ( \frac{1}{{Λ}_{x}} , \frac{1}{{Λ}_{y}} ) \qquad ( III )$$

where Λₓ and Λ_{y} are the periodicities of the gratings in the x and y-directions, respectively.

In K-Space diagrams, grating vectors are normalized by k₀, which is the wave vector of light in free space as shown in the following equations (IV) and (V):

$${k}_{0} = 2 π * ( \frac{1}{{Λ}_{0}} ) \qquad ( IV )$$

$${k}_{grating , norm} = \frac{{k}_{grating}}{{k}_{0}} = \frac{{Λ}_{0}}{{Λ}_{x}} , \frac{{Λ}_{0}}{{Λ}_{y}} \qquad ( V )$$

The above equations therefore show that the grating vector of diffraction gratings is determined by the periodicity (pitch/spacing between the center of adjacent gratings and direction) of the diffraction grating. Accordingly, the grating vector of a diffraction grating increases with the decreasing of the periodicities of the grating. Thus, a diffraction grating formed with a finer pitch or smaller period in turn has a larger grating vector.

In some embodiments, there may be grating vectors for additional higher diffractive orders. For example, the magnitudes of the grating vectors for the ±2 diffractive orders are twice that of the grating vectors for the ±1 diffractive orders, and magnitudes of the grating vectors the ±3 diffractive orders are three times that of the grating vectors for the ±1 diffractive orders. The fundamental grating vector K₁ is determined solely by the periodicity of the grating (direction and pitch). Since all the harmonics of the fundamental grating vector (e.g., K₋₁, K₂, K₋₃, etc.) are simply integer multiples of the fundamental K₁, then all diffraction directions of the diffraction grating 500 are also solely determined by the periodicity of the diffraction grating 500. The action of the diffraction grating 500 is to add the grating vectors to the in-plane component of the k-vector corresponding to the incident light ray or beam.

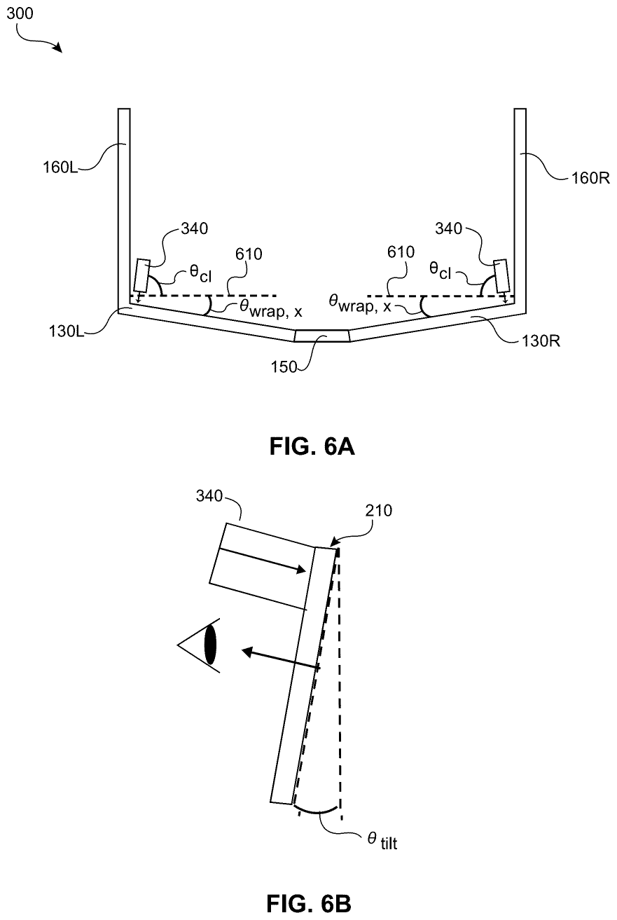

FIG. 6A illustrates a plan view of the near-eye display system 100 of FIG. 1, according to certain embodiments of the present disclosure. The left and right portions 130L, 130R extend from the left and right temporal extensions 160L, 160R, respectively, towards one another and are connected by the central portion 150. As mentioned above, the near-eye display system 100 of the present disclosure includes wrapping the waveguides of the left and right display systems 120L, 120R to provide a minimized or “rainbow artifact” free experience. In some embodiments, wrapping the left and right display systems 120L, 120R includes configuring the left and right portions 130L, 130R (and the associated left and right display systems 120L, 120R in each) of the frame 110 such that the left and right display systems 120L, 120R each extend from the left and right temporal extensions 160L, 160R, respectively, at greater than normal angles toward the central portion 150.

As shown in FIG. 6A, the left and right portions 130L, 130R may each extend at a wrap angle θ_{wrap(xy)} from the left and right temporal extensions 160L, 160R, respectively, towards the central portion 150 of the frame 110. θ_{wrap(xy)} is defined as the angle in the x and y-directions between the extension of each of the left and right display systems 120L, 120R (and the associated left and right display systems 120L, 120R in each) relative to a waveguide plane 610 extending normal the left and right temporal extensions 160L, 160R. When In some embodiments, which can be combined with other embodiments herein, the waveguide plane 610 is substantially parallel with the eyebox plane 220. In some embodiments, when θ_{wrap(x)} in the x-direction is C degrees, the left and right portions 130L, 130R extend substantially horizontally across a front surface of the eyes of the user. In such instances, the left and right portions 130L, 130R extend substantially parallel with the waveguide plane 610 in the x-direction and substantially normal to the left and right temporal extensions 160L, 160R. In another embodiment, when θ_{wrap(y)} in the y-direction is C degrees, the left and right portions 130L, 130R extend across a front surface of the eyes such that a plane substantially parallel with an outer surface 152L, 152R of the left and right portions 130L, 130R, respectively, is substantially flat and parallel with the waveguide plane 610 in the y-direction.

In some embodiments, which may be combined with other embodiments described herein, the left and right portions 130L, 130R may be wrapped in the x-direction, y-direction, or both. For example, FIG. 6A shows the left and right portions 130L, 130R formed in which the left and right portions 130L, 130R are wrapped in only the x-direction and therefore only θ_{wrap(x)} is greater than C degrees. As shown, the left and right portions 130L, 130R each extend slightly forward from the left and right temporal extensions 160L, 160R, respectively, at an angle (i.e. θ_{wrap(x)}) towards the central portion 150. In other embodiments, which may be combined with other embodiments herein, the left and right portions 130L, 130R may only be wrapped in the y-direction (not shown) in which only θ_{wrap(y)} is greater than C degrees.

Accordingly, θ_{wrap(xy)} corresponds to the angle of the waveguide display assemblies 210 in front of the eyes of the user. In some embodiments, the waveguide display assemblies 210 may be wrapped in both the x and y-directions. In some embodiments, the waveguide display assemblies 210 may be wrapped in only the x or y-direction. As shown in FIG. 6A, the waveguide display assemblies 210 in each of the left and right display systems 120L, 120R are wrapped in the x-direction at an θ_{wrap,x} angle. In some embodiments, θ_{wrap,x} may be greater than 10 degrees, such as between about 10 degrees and about 20 degrees, such as about 13 degrees, or such as about 15 degrees.

In some embodiments, wrapping the left and right display systems 120L, 120R also includes modifying the angle of the image light from the projector 340 to compensate for the θ_{wrap(xy)} angle of the waveguide display assemblies 210 such that the angle of the input light from the projector 340 to the left and right display systems 120L, 120R are off-normal in the wrap angle direction. The projector 340 for each of the left and right display systems 120L, 120R may therefore be configured to provide the image light as a compensated input where the image light is projected by the projector 340 at a compensated input angle θ_{Cl} towards each of the waveguide display assembly 210. θ_{Cl} of the projector 340 depends on the θ_{wrap(xy)} and may be determined using the following compensated wrap angle equation (VI):

$${θ}_{CI} = 90 ° - ( 2 \times {θ}_{wrap ( xy )} ) \qquad ( VI )$$

Accordingly, the compensated input angle θ_{Cl} of the image light from the projector 340 may be compensated in the x-direction, y-direction, or both. The combined use of the wrapping of the waveguide display assemblies 210 and angling of the corresponding projector 340 together referred herein as “compensated wrap”.

Referring to FIG. 6B, in an embodiment, which may be combined with other embodiments herein, the waveguide display assemblies 210 of the left and right display systems 120L, 120R including the associated projectors 304 may be also tilted by an amount θₜᵢₗₜ so as to provide the near-eye display system 100 with a pantoscopic tilt.

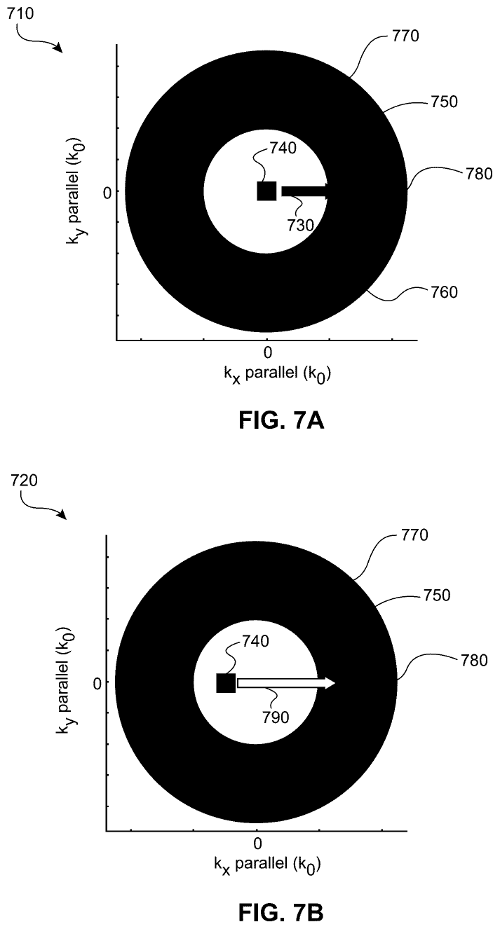

FIG. 7A shows a K-Space diagram 710 which illustrates the field-of-view (FOV) of input light beams that are coupled into a substrate (e.g., waveguide combiner). FIG. 7B shows a K-Space diagram 720 which illustrates the field-of-view (FOV) of input light beams that are coupled into a substrate (e.g., waveguide combiner) by a compensated wrapped diffraction grating, according to certain embodiments. The K-Space diagrams 710, 720 each include a larger circle 760 which defines the k-vectors of input light beams that can propagate within the substrate, and a smaller circle 750, which defines the k-vectors of input light beams that can propagate within a medium, such as air, that surrounds the substrate. The K-Space diagrams 710, 720 also each include a FOV 740 and an annulus 770 in the space between the smaller circle 750 and the larger circle 760. In K-Space, the FOV 740 encloses a set of k-vectors which corresponds to the input light beams. The annulus 770 defines the k-vectors of input light beams that can undergo guided propagation within the substrate.

As shown in FIG. 7A, the FOV 740 is centered inside the smaller circle 750. This position of the FOV 740 corresponds to the k-vectors of input light beams propagating generally in the ±z-direction. When the FOV 740 is within the smaller circle 750 in a K-Space diagram, it can represent the input light beams as they propagate from an image source, through free space, to the substrate. Each K-Space point within the FOV 740 corresponds to a k-vector which represents one of the input light beam directions. In order for the input light beams represented by the FOV 740 to undergo guided propagation within the substrate, the FOV 740 must be translated from inside the smaller circle 750 to the annulus 770.

Turning to FIG. 7A, K-Space diagram 710 also shows the translation shift of the FOV 740 in K-Space due to a coupling of the input light beams into the substrate by a diffraction grating, such as an input-coupler grating located at an entrance pupil of the substrate. The diffraction grating has an associated grating vectors (K₋₁, K₁) and diffracts the input light beams of the FOV 740 by a +1 diffractive order and a −1 diffractive order. In K-Space diagram 710, the diffraction of the input light beams (e.g., coupling of the input light beams from air into the substrate) is represented by the FOV 740 being translated in the k_{x-direction} by a grating vector 730 into the annulus 770 as shown by a FOV 780.

The extent of the translation of the FOV 740 to FOV 780 in K-Space corresponding to the diffraction of the input light beams by the diffraction gradient is dependent on the magnitude of the grating vector of the diffracting diffraction gradient. As mentioned above, the magnitude of the grating vectors 730 is dependent on and inversely proportion to the periodicity of the diffraction grating. As such, in order for the input-coupler grating to effectively couple the incident light from air into the substrate (as indicated by the translation of FOV 740 into the annulus 770 by the K₁ grating vector) the periodicity of the input-coupler grating is configured such that a magnitude of the grating vector (as indicated by a length of the K₁ grating vector in FIG. 7A) is sufficient to result in the translation of the FOV 740 into the annulus 770.

Diffraction gratings with grating vectors that result in translation of the FOV 740 outside of the annulus 770 would not be diffracted at all by the diffraction grating because those k-vectors are not permitted. Meanwhile, if the translated FOV 740 were to still lie inside the smaller circle 750 after translation by the diffraction grating, then the input light beams corresponding to those particular k-vectors would exit the substrate by transmitting through its planar face for failure to TIR and would not undergo guided propagation through the substrate.

Turning to FIG. 7B, K-Space diagram 720 shows the initial position of the FOV 740 inside the smaller circle 750 translated to the left in the −k_{x-direction}. It was observed that by wrapping the near-eye display system 100 such that the waveguide display assemblies 210 are angled by θ_{wrap(xy)}, the initial position of the FOV 740 regarding input light beams propagating towards the exposed diffraction gratings of the near-eye display system 100 (including input light beams from external and/or ambient light) is shifted inside the smaller circle 750 as shown in K-Space diagram 720. With the position of the FOV 740 shifted as shown in K-Space diagram 720, a grating vector 790 having a larger magnitude is required to translate the FOV 740 to the FOV 780 inside the annulus 770. As mentioned above, diffraction gratings are configured with certain periodicities, and thereby the associated grating vectors as needed for coupling the input light beams into the substrate the grating is intended to be used with. By wrapping the diffraction grating, the associated shift in the initial position of the FOV 740 as discussed herein allows use of diffraction gratings with larger grating vectors thereby enabling the corresponding diffraction grating to be formed with smaller periodicities. In some embodiments, the periodicities of the diffraction gratings that are exposed to the ambient environment may be wrapped and formed with grating periodicities in which the pitch is about 330 nanometers, or less than about 330 nanometers, such as about 300 nanometers, or about 250 nanometers, or about 200 nanometers.

When the diffraction grating is compensated and wrapped, the wrap enables the use of diffraction gratings with larger grating vectors k_{grating,wrap} increased by a k_{wrap(xy)} in which k_{wrap(xy)} is a function of the wrap angle θ_{wrap(xy)} of the corresponding diffraction grating, and wherein θ_{wrap,x} and θ_{wrap,y} each correspond to components of θ_{wrap(xy)} in the x and y-directions, respectively, as follows:

$${k}_{grating , wrap} = {k}_{grating} + {k}_{wrap ( xy )} \qquad ( VII )$$

$${k}_{wrap , x} = \frac{tan ( {θ}_{wrap , x} )}{\sqrt{{( tan ( {θ}_{wrap , x} ) )}^{2} + {( tan ( {θ}_{wrap , y} ) )}^{2} + 1}} \qquad ( VIII )$$

$${k}_{wrap , y} = \frac{tan ( {θ}_{wrap , y} )}{\sqrt{{( tan ( {θ}_{wrap , x} ) )}^{2} + {( tan ( {θ}_{wrap , y} ) )}^{2} + 1}} \qquad ( IX )$$

By configuring the exposed diffraction gratings of the near-eye display system 100 with larger grating vectors (enabled due to the wrapping of the corresponding display assemblies 120 as discussed above), the diffracted angle (θₒᵤₜ) of the first diffracted order (m=1) from input light beams increases. With reference to FIG. 5B, the larger grating vectors k_{grating,wrap} prevent rainbow artifacts from external input light beams incident on the exposed diffraction gratings at an angle θᵢₙ based the following grating equations (X):

$${θ}_{out} = {sin}^{- 1} ( \frac{{n}_{in} sin ( {θ}_{in} ) - m \times {k}_{grating , norm} \times sin ( {ϕ}_{grating} )}{{n}_{out}} ) \qquad ( X )$$

where nₒᵤₜ is the refractive index of the “out” medium (e.g., n₂), θₒᵤₜ is the angle of light in that medium, nᵢₙ is the refractive index of the “in” medium (e.g., n₁), θᵢₙ is the angle of light incident from that medium, m (0, +−1, +−2, . . . ) is the grating diffraction order, k_{grating, norm} is the normalized grating vector of the diffraction grating 500, and ϕ_{grating} is the angle of the gratings of the diffraction grating 500. Accordingly, the increased grating vectors of the exposed diffraction gratings cause external light at angles of incidence Bin to result in increased diffracted angle (θₒᵤₜ) so that less or no rainbow artifacts are visible to the user.

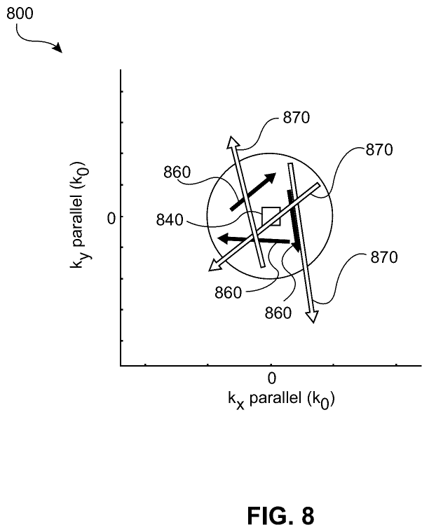

FIG. 8 shows a K-Space diagram 800 which illustrates a field-of-view (FOV) of exemplary external light beams that are supported in air, according to certain embodiments of the present disclosure. The K-Space diagram 800 shows an example of how use of diffraction gratings with larger grating vector (enabled by wrapping of the diffraction grating and smaller periodicities) can generally support less rainbow artifacts caused by external light beams being visible to the user.

K-Space diagram 800 includes a FOV 840 inside a circle 850. The position of the FOV 840 inside the circle 850 corresponds to the k-vectors of input light beams propagating generally in the ±z-direction. The K-Space diagram 800 also includes a plurality of k-vectors 860 and k-vectors 870 that represent external light beams from the ambient environment outside the FOV of the user that may produce visible rainbow artifacts. For diffraction gratings of the near-eye display system 100 exposed to the external/ambient environment when the near-eye display system 100 is in use, the wrapping of such diffraction gratings fabricated with smaller periodicities, such as less than 330 nm, correspondingly reduces the angles and wavelengths at which external light beams can couple into the waveguides of the near-eye display system 100 and create Rainbow. In some embodiments, the reduction enables the limiting of the coupling of external light beams to external light beams incident at large angles.

For example, as shown in K-Space diagram 800, external light beams from the ambient environment at large angles can be coupled into the near-eye display system 100 as shown by the starting points of the k-vectors 860, 870 inside the circle 850. The k-vectors 860, 870 of such externa light beams are correspondingly translated on the K-Space diagram 800 based on the associated grating vector of the coupling diffraction grating, as shown by the corresponding extension of each of the k-vectors 860, 870 on the K-Space diagram 800. In the example shown, the k-vectors 860 are shorter and correspond to the grating vector of diffraction gratings that are not wrapped and have larger periodicities. In contrast, the k-vectors 870 are longer and correspond to the larger grating vectors of the diffraction grating enabled by the wrapping of the diffraction grating and use of smaller periodicities, as discussed above. In K-Space diagram 800, if after translation of the k-vectors of the external light beams, the ending points of the k-vectors 860, 870 remain inside the circle 850, the corresponding external input light beams are coupled and produce visible rainbow artifacts to the user. On the other hand, if the k-vectors are translated out of the circle 850 as shown for each the k-vectors 870, such external light beams would not be coupled because the k-vectors of those external light beams would not be permitted. As such, K-Space diagram 800 shows how compensated wrapped diffraction gratings with larger grating vectors are more likely to eliminate the presence of rainbow artifacts than non-wrapped diffraction gratings with no compensation and smaller grating vectors due to the translation of the k-vectors of external light beams out of the circle 850.

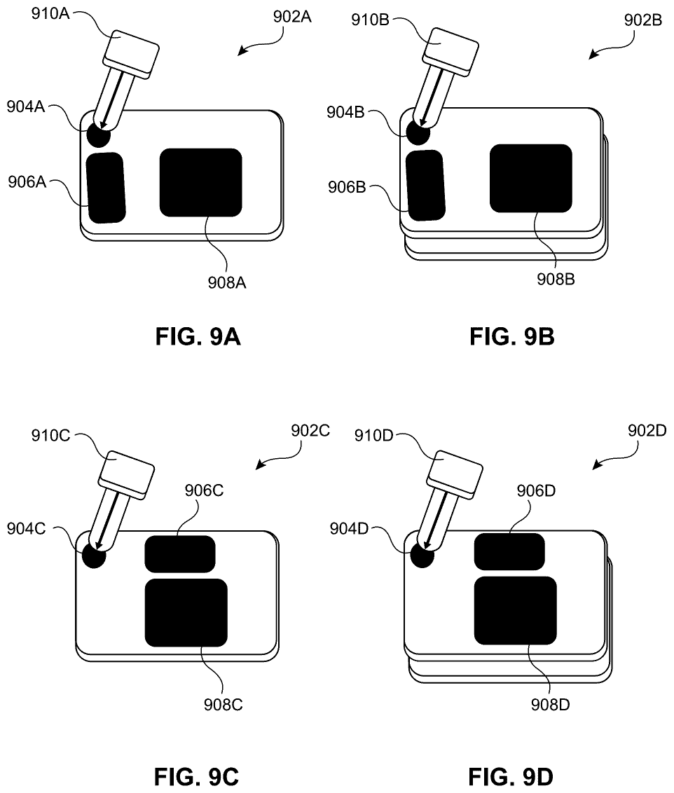

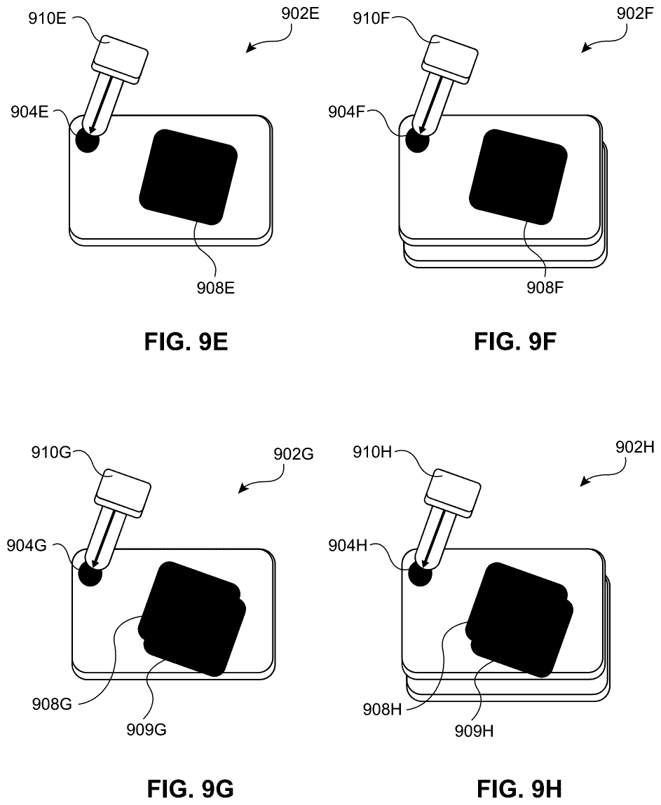

FIGS. 9A-9H show examples of waveguide architectures that may be wrapped as discussed above for use with the near-eye display system 100, according to certain embodiments. In each example, the angle of the image light from a corresponding projector may also be angled as discussed above to compensate for the θ_{wrap} angle of the wrapping of the waveguide architecture shown to provide compensated wrap to the waveguide.

In some embodiments, FIG. 9A shows an embodiment of a single-sheet vertical fold waveguide architecture 902A having an input coupling grating 904A, a pupil expander grating 906A, an output coupling grating 908A, and a projector 910A in which the projector 910A projects image light towards the input coupling grating 904A. In some embodiments, the single-sheet vertical fold waveguide architecture depicted in FIG. 9A may be configured as a multi-sheet vertical fold waveguide architecture 902B as shown in FIG. 9B.

In some embodiments, FIG. 9C shows an embodiment of a single-sheet horizontal fold waveguide architecture 902C having an input coupling grating 904C, a pupil expander grating 906C, an output coupling grating 908C, and a projector 910C in which the projector 910C projects image light towards the input coupling grating 904C. In some embodiments, the single-sheet horizontal fold waveguide architecture depicted in FIG. 9C may be configured as a multi-sheet vertical fold waveguide architecture as shown in FIG. 9D.

In some embodiments, FIG. 9E shows an embodiment of a single-sheet 2D waveguide architecture 902E having an input coupling grating 904E, an output coupling grating 908E, and a projector 910E in which the projector 910E projects image light towards the input coupling grating 904E. In some embodiments, the single-sheet 2D waveguide architecture depicted in FIG. 9E may be configured as a multi-sheet 2D waveguide architecture as shown in FIG. 9F.

In some embodiments, FIG. 9G shows an embodiment of a single-sheet double-sided waveguide architecture 902G having an input coupling grating 904G, a top output coupling grating 908G, a bottom output coupling grating 909G, and a projector 910G in which the projector 910G projects image light towards the input coupling grating 904G. In some embodiments, the single-sheet double-sided waveguide architecture depicted in FIG. 9G may be configured as a multi-sheet double-sided waveguide architecture as shown in FIG. 9H.

When introducing elements of the present disclosure or exemplary aspects or implementation(s) thereof, the articles “a,” “an,” “the” and “said” are intended to mean that there are one or more of the elements.

The terms “comprising,” “including” and “having” are intended to be inclusive and mean that there may be additional elements other than the listed elements.

While the foregoing is directed to embodiments of the present disclosure, other and further implementations of the disclosure may be devised without departing from the basic scope thereof, and the scope thereof is determined by the claims that follow.

What is claimed is:

1. A waveguide display assembly, comprising:
a light engine to project light;
a waveguide combiner configured to extend across a user's eye at a wrap angle θ_{wrap(xy)} relative to a waveguide plane;
an input coupling grating for coupling light from the light engine into the waveguide combiner; and
one or more coupling gratings exposed to an ambient environment of the waveguide display assembly, wherein the waveguide plane is substantially parallel with an eyebox plane in front of the user's eye, and the light engine is configured to project light toward the input coupling grating at a compensation angle θ_{Cl} determined using the wrap angle θ_{wrap(xy)} and following equation:
$${θ}_{CI} = 90 ° - ( 2 \times {θ}_{wrap ( xy )} ) .$$

2. The waveguide display assembly of claim 1, wherein the wrap angle θ_{wrap(xy)} comprises a wrap angle θ_{wrap,y} in the y-direction, and a wrap angle θ_{wrap,x} in the x-direction, wherein the wrap angle θ_{wrap,y} is 0 degrees and the wrap angle θ_{wrap,x} is between about 10 degrees and about 20 degrees.

3. The waveguide display assembly of claim 2, wherein each of the one or more exposed coupling gratings comprises a grating periodicity having a pitch less than about 330 nanometers.

4. The waveguide display assembly of claim 1, wherein the wrap angle θ_{wrap(xy)} comprises a wrap angle θ_{wrap,y} in the y-direction relative to the waveguide plane, and a wrap angle θ_{wrap,x} in the x-direction relative to the waveguide plane, and wherein a grating vector k_{grating} of each of the one or more exposed coupling gratings is increased to a wrapped grating vector k_{grating,wrap} determined using θ_{wrap(xy)} and the following equations:
$${k}_{grating , wrap} = {k}_{grating} + {k}_{wrap ( xy )}$$
$${k}_{wrap , x} = \frac{tan ( {θ}_{wrap , x} )}{\sqrt{{( tan ( {θ}_{wrap , x} ) )}^{2} + {( tan ( {θ}_{wrap , y} ) )}^{2} + 1}}$$
$${k}_{wrap , y} = \frac{tan ( {θ}_{wrap , y} )}{\sqrt{{( tan ( {θ}_{wrap , x} ) )}^{2} + {( tan ( {θ}_{wrap , y} ) )}^{2} + 1}} .$$

5. The waveguide display assembly of claim 1, wherein each of the one or more exposed coupling gratings comprises a grating periodicity having a pitch less than about 330 nanometers.

6. The waveguide display assembly of claim 1, wherein the one or more exposed coupling gratings comprises an output coupling grating.

7. The waveguide display assembly of claim 5, wherein the wrap angle θ_{wrap(xy)} comprises a wrap angle θ_{wrap,y} in the y-direction relative to the waveguide plane, and a wrap angle θ_{wrap,x} in the x-direction relative to the waveguide plane, and wherein each of the one or more exposed coupling gratings on the waveguide combiner comprises a wrapped grating vector k_{grating,wrap}, determined using the following equations:
$${k}_{grating} = 2 π * ( \frac{1}{{Λ}_{x}} , \frac{1}{{Λ}_{y}} )$$
$${k}_{grating , wrap} = {k}_{grating} + {k}_{wrap ( xy )}$$
$${k}_{wrap , x} = \frac{tan ( {θ}_{wrap , x} )}{\sqrt{{( tan ( {θ}_{wrap , x} ) )}^{2} + {( tan ( {θ}_{wrap , y} ) )}^{2} + 1}}$$
$${k}_{wrap , y} = \frac{tan ( {θ}_{wrap , y} )}{\sqrt{{( tan ( {θ}_{wrap , x} ) )}^{2} + {( tan ( {θ}_{wrap , y} ) )}^{2} + 1}} .$$

8. The waveguide display assembly of claim 1, wherein the wrap angle θ_{wrap(xy)} comprises a wrap angle θ_{wrap,y} in the y-direction relative to the waveguide plane, and a wrap angle θ_{wrap,x} in the x-direction relative to the waveguide plane, and wherein each of the one or more coupling gratings has a minimum pitch (Λₓ, Λ_{y}) for coupling light into the waveguide combiner and satisfy the following equations:
$${Λ}_{x} , {Λ}_{y} = \frac{2 π}{{k}_{grating , wrap}}$$
$${k}_{grating , wrap} = {k}_{grating} + {k}_{wrap ( xy )}$$
$${k}_{wrap , x} = \frac{tan ( {θ}_{wrap , x} )}{\sqrt{{( tan ( {θ}_{wrap , x} ) )}^{2} + {( tan ( {θ}_{wrap , y} ) )}^{2} + 1}}$$
$${k}_{wrap , y} = \frac{tan ( {θ}_{wrap , y} )}{\sqrt{{( tan ( {θ}_{wrap , x} ) )}^{2} + {( tan ( {θ}_{wrap , y} ) )}^{2} + 1}} .$$

9. The waveguide display assembly of claim 1, wherein the one or more exposed coupling gratings comprises a single-sheet vertical fold architecture.

10. The waveguide display assembly of claim 1, wherein the one or more exposed coupling gratings comprises a single-sheet horizontal fold architecture.

11. The waveguide display assembly of claim 1, wherein the one or more exposed coupling gratings comprises a single-sheet 2D architecture.

12. The waveguide display assembly of claim 1, wherein the one or more exposed coupling gratings comprises a single-sheet double-sided architecture.

13. The waveguide display assembly of claim 1, wherein the one or more exposed coupling gratings comprises a multi-sheet grating architecture.

14. A near-eye display system, comprising:
a frame,
a light engine to project light; and
a waveguide display comprising:
a waveguide combiner configured to extend across a user's eye at a wrap angle θ_{wrap(xy)} relative to a waveguide plane;
an input coupling grating for coupling light from the light engine into the waveguide combiner; and
one or more coupling gratings formed on or in a surface of the waveguide combiner and exposed to an ambient environment of the waveguide display assembly,
wherein the waveguide plane is substantially parallel with an eyebox plane in front of the user's eye, and the light engine is configured to project light toward the input coupling grating at a compensation angle θ_{Cl} determined using the wrap angle θ_{wrap(xy)} and following equation:
$${θ}_{CI} = 90 ° - ( 2 \times {θ}_{wrap ( xy )} ) .$$

15. The near-eye display system of claim 14, wherein the wrap angle θ_{wrap(xy)} comprises a wrap angle θ_{wrap,y} in the y-direction, and a wrap angle θ_{wrap,x} in the x-direction, wherein the wrap angle θ_{wrap,y} is 0 degrees and the wrap angle θ_{wrap,x} is between about 10 degrees and about 20 degrees.

16. The near-eye display system of claim 15, wherein the wrap angle θ_{wrap(xy)} comprises a wrap angle θ_{wrap,y} in the y-direction relative to the waveguide plane, and a wrap angle θ_{wrap,x} in the x-direction relative to the waveguide plane, and wherein a grating vector k_{grating} of each of the one or more exposed coupling gratings on the waveguide combiner is increased to a wrapped grating vector k_{grating,wrap} using the θ_{wrap(xy)} of the waveguide combiner by satisfying the following equations:
$${k}_{grating , wrap} = {k}_{grating} + {k}_{wrap ( xy )}$$
$${k}_{wrap , x} = \frac{tan ( {θ}_{wrap , x} )}{\sqrt{{( tan ( {θ}_{wrap , x} ) )}^{2} + {( tan ( {θ}_{wrap , y} ) )}^{2} + 1}}$$
$${k}_{wrap , y} = \frac{tan ( {θ}_{wrap , y} )}{\sqrt{{( tan ( {θ}_{wrap , x} ) )}^{2} + {( tan ( {θ}_{wrap , y} ) )}^{2} + 1}} .$$

17. The near-eye display system of claim 14, wherein each of the one or more exposed coupling gratings comprises a grating periodicity having a pitch less than about 330 nanometers.

18. The near-eye display system of claim 14, wherein the wrap angle θ_{wrap(xy)} comprises a wrap angle θ_{wrap,y} in the y-direction relative to the waveguide plane, and a wrap angle θ_{wrap,x} in the x-direction relative to the waveguide plane, and wherein each of the one or more coupling gratings has a minimum pitch (Λₓ, Λ_{y}) for coupling light in the waveguide combiner and satisfy the following equations:
$${Λ}_{x} , {Λ}_{y} = \frac{2 π}{{k}_{grating , wrap}}$$
$${k}_{grating , wrap} = {k}_{grating} + {k}_{wrap ( xy )}$$
$${k}_{wrap , x} = \frac{tan ( {θ}_{wrap , x} )}{\sqrt{{( tan ( {θ}_{wrap , x} ) )}^{2} + {( tan ( {θ}_{wrap , y} ) )}^{2} + 1}}$$
$${k}_{wrap , y} = \frac{tan ( {θ}_{wrap , y} )}{\sqrt{{( tan ( {θ}_{wrap , x} ) )}^{2} + {( tan ( {θ}_{wrap , y} ) )}^{2} + 1}} .$$

19. A near-eye display system, comprising:
a frame; and
a waveguide display assembly, comprising:
a waveguide combiner extending at a wrap angle θ_{wrap(xy)} relative to a waveguide plane, wherein the waveguide plane is substantially parallel with an eyebox plane in front of a user's eye;
an out-coupler grating having a pitch (Λₓ, Λ_{y}), wherein the wrap angle θ_{wrap(xy)} of the waveguide combiner increases a grating vector k_{grating} of the out-coupler grating such that all angles of incidence Bin of light from an external light results in a diffracted angle θₒᵤₜ, that produces no visible rainbow artifacts within a 30 degrees field of view (FOV) cone of a user by satisfying the following equation:
$${θ}_{out} = {sin}^{- 1} ( \frac{{n}_{in} sin ( {θ}_{in} ) - m \times {k}_{grating , norm} \times sin ( {ϕ}_{grating} )}{{n}_{out}} )$$
wherein nₒᵤₜ is the refractive index of the “out” medium external to the out-coupler grating, nᵢₙ is the refractive index of the “in” medium of the out-coupler grating, m is the grating diffraction order, and k_{grating, norm} is the normalized grating vector of the out-coupler grating.

20. The near-eye display system of claim 19, wherein the grating vector k_{grating} is increased to a wrapped grating vector k_{grating,wrap} based on the θ_{wrap(xy)} of the waveguide combiner by satisfying the following equations:
$${k}_{grating , wrap} = {k}_{grating} + {k}_{wrap ( xy )}$$
$${k}_{wrap , x} = \frac{tan ( {θ}_{wrap , x} )}{\sqrt{{( tan ( {θ}_{wrap , x} ) )}^{2} + {( tan ( {θ}_{wrap , y} ) )}^{2} + 1}}$$
$${k}_{wrap , y} = \frac{tan ( {θ}_{wrap , y} )}{\sqrt{{( tan ( {θ}_{wrap , x} ) )}^{2} + {( tan ( {θ}_{wrap , y} ) )}^{2} + 1}} .$$
